(19) United States
(12) Patent Application Publication
(10) Pub. No.: US 2007/0097222 A1
(43) Pub. Date: May 3, 2007

(54) Information processing apparatus and control method thereof

(76) Inventor: Takeshi Makita, Hino-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/586,592

(22) Filed: Oct. 26, 2006

(30) Foreign Application Priority Data
Oct. 27, 2005 (JP) 2005-313299

(51) Int. Cl. H04N 5/232

(52) U.S. Cl. 348/211.12

(57) ABSTRACT

According to one embodiment, when moving image data and speech data received via a communications device are displayed on a display unit, speech data corresponding to the moving image data are appropriately distributed to output units and loudspeakers and then output in accordance with a position of the displayed moving image data.

### CROSS-REFERENCE TO RELATED APPLICATIONS

This application is based upon and claims the benefit of priority from Japanese Patent Application No. 2005-313299, filed Oct. 27, 2005, the entire contents of which are incorporated herein by reference.

### BACKGROUND

1. Field

One embodiment of this invention relates to a video conference system and, more particularly, to an information processing apparatus and a control method thereof, capable of improving a sense of realism in speech of a speaker by emphasizing speech from a loudspeaker on a monitor side on which a speaker is displayed.

2. Description of the Related Art

In a video conference system as disclosed in Jpn. Pat. Appln. KOKAI Publication No. 9-307869, for example, a main participant, of plural participants, is displayed and emphasized.

According to this technique, however, the speaker's speech is not considered, and it is often difficult to discriminate which speaker has made the speech output from a loudspeaker.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 shows an illustration of a configuration of a video conference system to which an information processing apparatus according to a first embodiment of the present invention is applied;

FIG. 2 shows an illustration of displaying image data on a display;

FIG. 3 shows an illustration of displaying image data on a display;

FIG. 4 shows a flowchart of steps in a control method to which the information processing apparatus of the present invention is applied;

FIG. 5 shows an illustration of displaying image data on a display, according to a modified example of the first embodiment;

FIG. 6 shows an illustration of displaying image data on a display, according to a modified example of the first embodiment; and

FIG. 7 shows an illustration of a configuration of a video conference system to which an information processing apparatus according to a second embodiment of the present invention is applied.

### DETAILED DESCRIPTION

Various embodiments according to the invention will be described hereinafter with reference to the accompanying drawings. In general, according to one embodiment of the invention, an information processing apparatus comprising communications unit, display unit, a plurality of speech output unit, acquisition unit, and distribution unit. The acquisition unit acquires a plurality of moving image data items and speech data items received via the communications unit. When the plurality of moving image data items acquired by the acquisition unit are displayed by the display unit, the distribution unit appropriately distributes the speech data item corresponding to each of the displayed moving image data items to the plurality of speech output unit and allows the speech output unit to output the speech data item in accordance with a position of the displayed moving image data item.

Embodiments of the present invention will be explained below with reference to the accompanying drawings.

(First Embodiment)

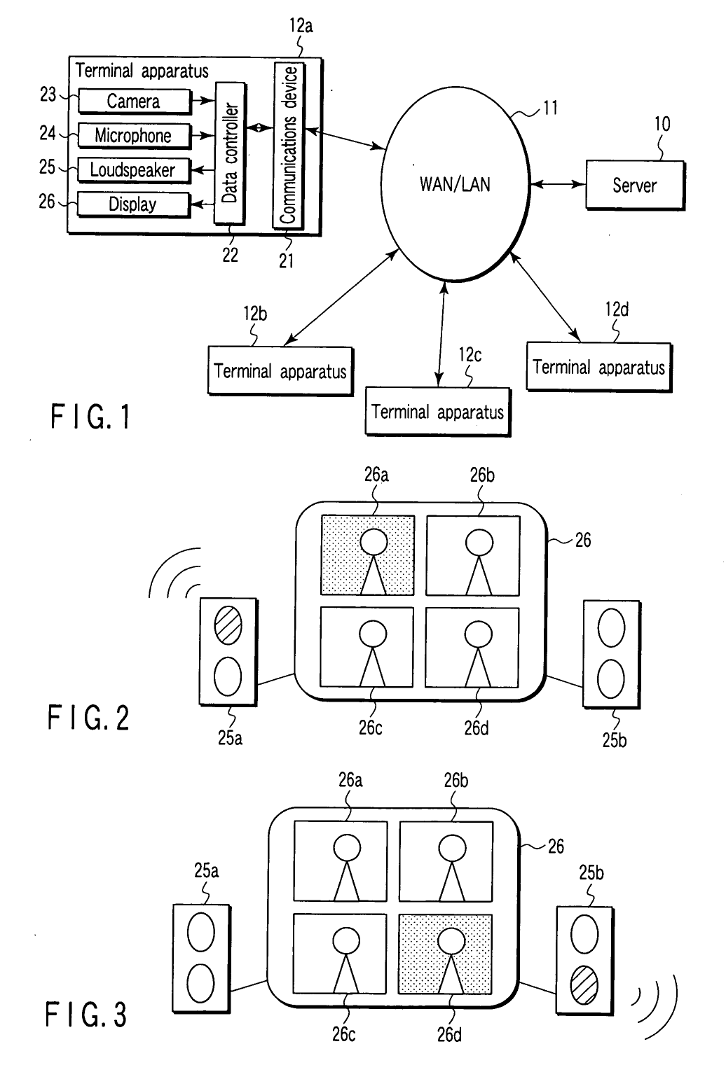

FIG. 1 shows an illustration of a configuration of a video conference system to which an information processing apparatus according to a first embodiment of the present invention is applied.

The video conference system comprises terminal apparatuses 12a to 12d, a WAN/LAN 11, and a server 10 which synthesizes data received from the terminal apparatuses 12a to 12d and distributes the synthesized data to each of the terminal apparatuses 12a to 12d via the WAN/LAN 11.

The terminal apparatuses 12a to 12d have the same structure. For example, the terminal apparatus 12a comprises a camera 23 which inputs images, a microphone 24 which inputs speech, a data controller 22 which receives data from the camera 23 and the microphone 24 and converts the received data into communications data or processes data received from the server 10, a display unit 26 which reproduces image data (moving image data and audio data), a loudspeaker 25 which reproduces audio data, and a communications device 21 which receives communications data from the server 10.

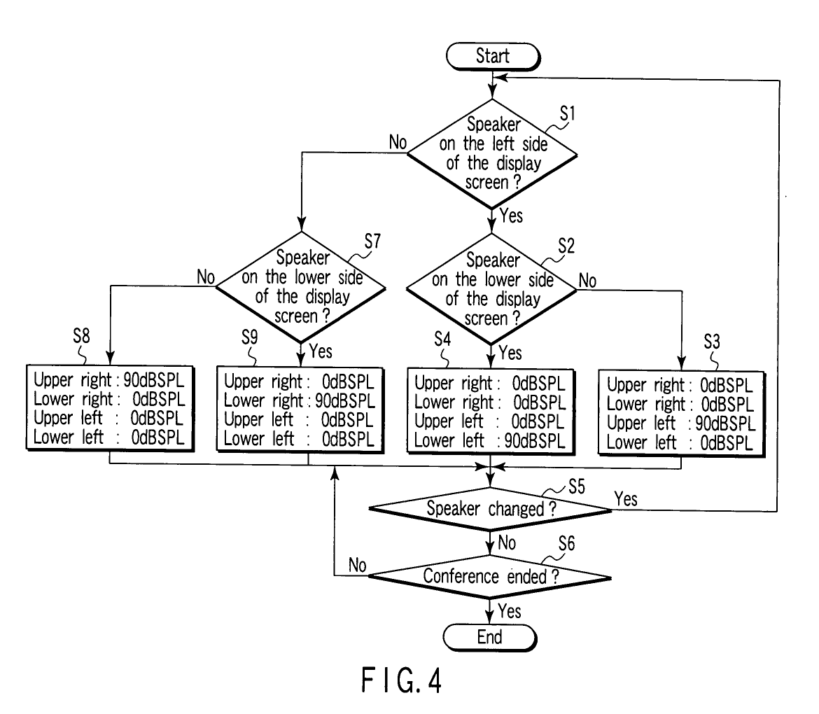

FIG. 2 and FIG. 3 show illustrations of displaying image data items 26a to 26d on the display unit 26. FIG. 4 shows a flowchart of steps in a control method to which the information processing apparatus of the present invention is applied.

First, the terminal apparatus 12a acquires the image data (moving image data and audio data) received via the communications device 21 and displays the image data 26a to 26d on the display unit 26.

The terminal apparatus 12a discriminates whether or not the speaker is on the left side of the display screen (step S1). Since the display screen 26a of the speaker is on the left side (YES of step S1) as shown in FIG. 2, the terminal apparatus 12a discriminates whether or not the speaker is on the lower side of the display screen (step S2). As the display screen 26a of the speaker is on the upper side (NO of step S2), speech of, for example, 90 dB SPL is output from an upper output unit of a left speaker 25a and is not output from the other speaker output units (step S3).

Next, the terminal apparatus 12a discriminates whether or not the speaker has changed (step S5). If the speaker is on the display screen 26d as shown in, for example, FIG. 3, the terminal apparatus 12a discriminates that the speaker has changed (YES of step S5) and the operation returns to step S1 to output the speech from an appropriate output unit of the loudspeaker.

On the other hand, if the terminal apparatus 12a discriminates that the speaker has not changed (NO of step S5), the terminal apparatus 12a discriminates that speaking has not been further conducted and the video conference is ended (step S6).

If it is discriminated at step S2 that the display screen of the speaker is on the lower side (YES of step S2), speech of, for example, 90 dB SPL is output from a lower output unit of the left speaker 25a and is not output from the other speaker output units (step S4).

If it is discriminated at step S1 that the display screen of the speaker is on the right side (NO of step S1), it is discriminated whether or not the speaker is on the lower side of the display screen (step S7). If it is discriminated that the speaker is on the lower side of the display screen (YES of step S7), speech of, for example, 90 dB SPL is output from a lower output unit of a right speaker 25b and is not output from the other speaker output units (step S9).

On the other hand, if it is discriminated that the speaker is on the upper side of the display screen (NO of step S7), speech of, for example, 90 dB SPL is output from an upper output unit of a right speaker 25b and is not output from the other speaker output units (step S8).

As for the speech output value distribution of the loudspeaker 25, an output of, for example, 10 dB SPL that is clearly smaller than the output of 90 dB SPL from the output unit of the main speaker which outputs the speech may be output from the output units of the other speaker.

Thus, the video conference system rich in a sense of realism, capable of executing the processing of emphasizing the speech output from the loudspeaker can be executed on the basis of the display position of the speaker, and capable of outputting the speech in accordance with the displayed position of the speaker, can be constructed.

### MODIFIED EXAMPLE OF THE FIRST EMBODIMENT

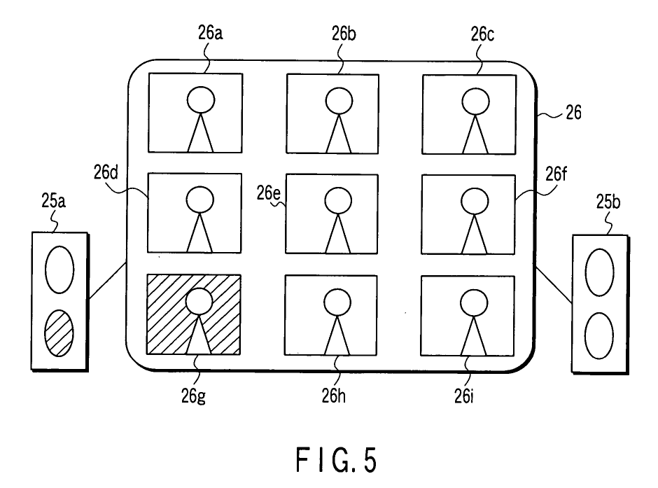

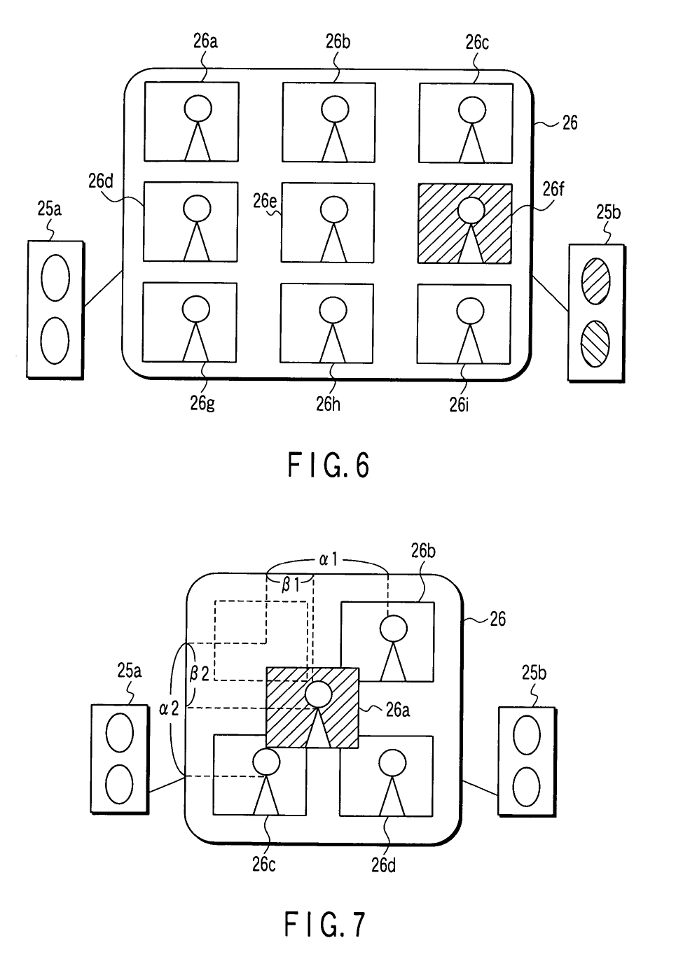

Next, a modified example of the first embodiment will be described with reference to FIG. 5 and FIG. 6.

The modified example of the first embodiment has a characteristic of setting, for example, nine display screens of the speaker on the display unit.

The display screens of the speaker synchronize with the speaker output units, similarly to the first embodiment. For example, as shown in FIG. 5, if the display screen of the speaker is a display screen 26g, speech of, for example, 90 dB SPL is output from the lower output unit of the left speaker 25a and is not output from the other speaker output units, since the display screen 26g is on the lower left side of the display unit 26.

In addition, for example, as shown in FIG. 6, if the display screen of the speaker is a display screen 26f, speech of, for example, 90 dB SPL is output from both the output units of the right speaker 25b and is not output from the other speaker output units, since the display screen 26f is on the central right side of the display unit 26.

The number of display screens to be displayed on the display unit 26 is not limited to the above-described embodiments if the output speech appropriately synchronizes with the display screens of the speaker.

Therefore, even if the number of display screens to be displayed on the display unit is increased, the output speech can appropriately synchronize with the display screens of the speaker.

(Second Embodiment)

FIG. 7 shows an illustration of display screens in a video conference system to which an information processing apparatus according to the second embodiment of the present invention is applied.

In the second embodiment, the speech is also output appropriately in a case where the display screen of the speaker is moved by an input device such as a mouse, remote controller, etc.

For example, movement of the display screen 26a to the lower right side as shown in FIG. 7 will be described. It can be understood that the moved display screen 26a is moved by β1 to the right side and by β2 to the lower side from the initial position.

The rate of lateral movement of the display screen 26a and the output distribution from the output units of the speakers can be obtained by calculating the balance ratio in the lateral direction.

Since the lateral distance between the display screen 26a and the display screen 26b is, for example, α1, the moved display screen 26a is located at a position of β1: α1−β1 in the lateral direction. The output distribution of the speech output of the left loudspeaker 25a and the right loudspeaker 25b is thereby set at β2: α1−1.

The rate of longitudinal movement of the display screen 26a can be obtained by calculating the longitudinal balance ratio. Since the longitudinal distance between the display screen 26a and the display screen 26c is, for example, α2, the moved display screen 26a is located at a position of α2: α2−β2 in the longitudinal direction. The output distribution of the speech output of the upper and lower output units in each of the loudspeaker 25a and the loudspeaker 25b is thereby set at β2:α2−β2.

Then, the output distribution is determined in the following manner.

If the display unit 26 is shaped in a square, α1=α2. In addition, the numerical values are assumed as follows.
α1=α2=100 cm
α1=40 cm
β2=30 cm

Thus, the distribution of the left and right speech outputs is
β1:α1−β1=40:60

and the distribution of the upper and lower speech outputs is
β2:α2−β2=30:70

Therefore, the output distribution of the output units of the loudspeakers is

Upper output unit of the right loudspeaker 25a=about 12 dB SPL

Lower output unit of the right loudspeaker 25a=about 28 dB SPL

Upper output unit of the left loudspeaker 25b=about 18 dB SPL

Lower output unit of the left loudspeaker 25b=about 42 dB SPL

In the above-described embodiments, the number of loudspeakers is two and the number of output units in each loudspeaker is two. However, the number of loudspeakers and the number of output units in each loudspeaker are not limited to those if the output speech appropriately synchronizes with the display screen of the speaker.

As a result, if the display screen of the speaker is moved on the display unit, the speech can be output in synchronization with the moved display screen.

The present invention is not limited to the embodiments described above but the constituent elements of the invention can be modified in various manners without departing from the spirit and scope of the invention. Various aspects of the invention can also be extracted from any appropriate combination of a plurality of constituent elements disclosed in the embodiments. For example, some constituent elements may be deleted in all of the constituent elements disclosed in the embodiments. The constituent elements described in different embodiments may be combined arbitrarily.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus, comprising:
communications unit;
display unit;
a plurality of speech output unit; and
acquiring a plurality of moving image data items and speech data items received via the communications unit and when the plurality of moving image data items acquired by the acquisition unit are displayed by the display unit, appropriately distributing the speech data item corresponding to each of the displayed moving image data items to the plurality of speech output unit and allowing the speech output unit to output the speech data item in accordance with a position of the displayed moving image data item.

2. The apparatus according to claim 1, wherein the plurality of speech output unit are loudspeakers arranged at predetermined positions and speech is output with emphasis from at least one of the loudspeakers close to the position of the displayed moving image data item.

3. The apparatus according to claim 2, wherein each of the speakers has a plurality of speech output units and the speech is output with emphasis from at least one of the speech output units of the loudspeakers close to the position of the displayed moving image data item.

4. The apparatus according to claim 1, wherein the plurality of speech output unit are loudspeakers arranged at predetermined positions and speech is output only from at least one of the loudspeakers close to the position of the displayed moving image data item.

5. The apparatus according to claim 4, wherein each of the speakers has a plurality of speech output units and the speech is output only from at least one of the speech output units of the loudspeakers close to the position of the displayed moving image data item.

6. The apparatus according to claim 1, wherein when a display range of the moving image data item displayed on the display unit is moved, the speech data item is appropriately redistributed to the plurality of speech output unit and output in response to the moved position in the display unit.

7. The apparatus according to claim 1, wherein when the speech data items corresponding to not less than two moving image data items, of the plurality of moving image data items, exist simultaneously, the speech data items are output simultaneously.

8. A method of controlling an information processing apparatus comprising communications unit, display unit, and a plurality of speech output unit,
acquiring a plurality of moving image data items and speech data items received via the communications unit and when the plurality of moving image data items acquired by the acquisition unit are displayed by the display unit, appropriately distributing the speech data item corresponding to each of the displayed moving image data items to the plurality of speech output unit and allowing the speech output unit to output the speech data item in accordance with a position of the displayed moving image data item.

9. The method according to claim 8, wherein the plurality of speech output unit are loudspeakers arranged at predetermined positions and speech is output with emphasis from at least one of the loudspeakers close to the position of the displayed moving image data item.

10. The method according to claim 9, wherein each of the speakers has a plurality of speech output units and the speech is output with emphasis from at least one of the speech output units of the loudspeakers close to the position of the displayed moving image data item.
